(19) United States
(12) Patent Application Publication
(10) Pub. No.: US 2004/0065531 A1
(43) Pub. Date: Apr. 8, 2004

(54) Blade crossbar

(76) Inventor: David N. Richter, Mexico, MO (US)

Correspondence Address: SQUARE D COMPANY, INTELLECTUAL PROPERTY DEPARTMENT, 1415 SOUTH ROSELLE ROAD, PALATINE, IL, 60067, US

(21) Appl. No.: 10/266,336

(22) Filed: Oct. 8, 2002

(51) Int. Cl. H01H 75/00

(52) U.S. Cl. 200/15

(57) ABSTRACT

A system for providing circuit protection, wherein the system comprises a blade suspension assembly. The assembly comprises a molded blade crossbar including integral skirts positioned to separate poles attached to the blade crossbar. Integral blade rest and blade carrier mounts further reduce complexity. Simplicity and cost advantages are obtained using poles having substantially identical blade carriers. Complexity and mechanism size is further reduced by using a combination blade stop and pivot pin hold down bracket. A base is provided with a web to further separate poles. An opening in the web is adapted to receive the suspension assembly. A separate jacket may be removably attached to the base in cooperating relation with an integral skirt to form a phase barrier between adjacent poles. The jacket may be adapted to interface with the opening in the web and overlap the skirt.

### FIELD OF THE INVENTION

The present invention generally relates to electrical connections, circuit breakers and switches, and more particularly to a blade crossbar and complimentary components.

### BACKGROUND OF THE INVENTION

Circuit breakers and switches are commonly used in electrical connections to control current. Although the invention will be described with respect to circuit breakers, one of ordinary skill in the art will understand the present invention is equally applicable to switches and other electrical connection componentry, without regard to use of designations such as circuit breaker or switch or the like. Additionally, some embodiments are directed toward componentry that directly affect, or are directly effected by, current in an electrical connection.

Circuit breakers are commonly used for providing automatic circuit interruption upon detection of undesired over current conditions on the circuit being monitored. These over current conditions include, among others, overload conditions, ground faults and short-circuit conditions. Circuit breakers typically include an electrical contact on a movable arm (a/k/a blade), which rotates away from a stationary contact to interrupt the current path. The type of over current condition dictates how quickly the arm must rotate. For example, in response to over current conditions at relatively low magnitudes, present for a long period of time, circuit breakers generally move the arm to break the current path by tripping a spring-biased latch mechanism which forces the contact on the arm away from the fixed contact.

Spring-biased latch mechanisms are, however, usually relatively slow. Thus, in response to over current conditions at relatively high magnitudes, circuit breakers must break (or blow-open) the current path very quickly, i.e., reacting much faster than the reaction time for known spring-biased latch mechanisms In either case of tripping or blowing open, the contact arm must rotate to an open position as fast and as simply and reliably as possible

A variety of circuit breaker designs attempting to achieve the objectives of quickness and reliability have succeeded, or failed, to varying degrees, each having its own advantages and disadvantages. Generally, the speed and reliability with which the design breaks the current path is directly related to the complexity of the design. Thus, faster and more electrically reliable designs generally involve more complex mechanisms. Unfortunately, the more complex the mechanism is, the higher the associated manufacturing costs are. More complex mechanisms are also more prone to mechanical failure.

One design having greater success at optimizing these conflicting objectives is taught in U.S. Pat. No. 5,539,167, which is commonly assigned with this application and is incorporated herein by reference in its entirety. Although the design taught in U.S. Pat. No. 5,539,167 is relatively uncomplicated, an object of the present invention is much simpler, more reliable and more economical design.

### OBJECTS OF THE INVENTION

Another objective is to provide an economical means for assembling a reliable mechanism for affecting an electrical connection. A further objective is to provide a kit for forming such a mechanism. Another objective is to provide the kit with substantially similar components to enable ease of assembly and to leverage economies-of-scale. A further objective is to provide an integrated one-piece platform around which the mechanism can be built up.

A related object of the invention is to provide a mechanism that provides circuit protection in an electronic connection where the mechanism is reliable and simple in comparison to prior art mechanism A further objective is to provide such a mechanism in an embodiment comprising a blade suspension system and associated base.

Another object, in providing protection in an electrical connection, includes providing a blade that is adapted for increased opening and over travel. Another object is to provide a lighter simpler blade.

Another object is to provide a breaker in which roughly the same contact pressure is produced in each pole of the breaker. A related objective is to produce or aid producing this contact pressure with a flat rate torsion spring. A related objective is to produce this contact pressure with a torsion spring having less mass and generating a lower spring force in a blow off configuration as compared to that generated in prior art blade suspension assemblies.

Another objective is to reduce contact pressure variance over a wide range or blade travel. A related object is to provide a flat-rate contact pressure spring that will produce little contact pressure variance over a wide range of over travel. A related objective is to achieve reliable operation. A further objective is to obtain advantages of a flat rate contact pressure spring while achieving reliability in operation. A related objective is avoid spring set during assembly or blade opening at high fault current.

Another objective, which relates to simplifying a blade mechanism, is to provide a blade carrier with arms set to interface with one set of arms of the contact pressure spring (e.g., the tangs extending from the loop ends are pressure fitted into the arms while the loops interface with the blade).

Another object is to enable all blades in, for example, a three-pole mechanism, to pivot about the same point, e.g., a common axis. A related objective is to allow this common axis to rotate about a parallel axis, where the rotation is based on current conditions or external input, such as manually closing a circuit.

A further objective is to attach the blade carrier to a crossbar while maintaining or increasing clearance for a blade to blow open. A related objective in simplifying the mechanism is to adapt the carrier and the crossbar to be coupled together with low-height attachments, for example two lower rivets, thereby providing necessary clearance for the blades to blow open during high fault levels.

Another objective is to isolate a pole in an electrical connection from adjacent poles in the connection. A related objective is to reduce the physical material transferring from a pole to an adjacent pole.

Another objective is to achieve some electrical isolation between a pole and an adjacent pole. A related objective is to reduce phase interaction between poles.

Another objective is to provide a blade crossbar that has means to keep pole material from transferring between poles during high fault interruptions A related objective is to provide the blade crossbar with integral skirts. A further objective is to enable the skirts to cooperate with a base supporting crossbar

Another object is to simplify a blade mechanism by providing a common set of parts for all poles. A further objective is to adapt mechanism connection parts to be attached to any one of substantially similar poles.

Another object is to achieve pole to pole isolation with, for example, a molded crossbar having integral skirts separating the poles. A further objective is to reduce the passing of gases and conductive material between poles by positioning the skirts to interface with slots in a base containing the crossbar.

A further objective is to enclose the skirt, which is positioned in slots in the base; and a still further objective is to complete the enclosing of the skirt sufficiently to further provide a phase barrier between poles. A related objective is to provide a phase barrier between the poles, wherein the phase barrier comprises a jacket positioned to cooperate with the skirt. Another objective concerning simplicity and reliability is to readily form the phase barrier by slipping a jacket on the skirt. A related objective is adapt the jacket to snuggly fit in an opening of a web of the base, wherein the web also functions as a barrier between poles.

Another objective is to provide an improved blade stop. A further objective is to combine advantages of a blade stop with those of a pivot pin hold down bracket. A related objective is to provide a cover for the base that interfaces the pivot pin hold down bracket at a pivot point and that interfaces with the blade stop. Further objective is to adapt the cover and a stop-bracket such that the cover simultaneously interfaces the pivot pin hold down bracket near a pivot point at an end of a stop tang of the blade stop, wherein the stop-bracket is a combination comprising the pivot pin hold down bracket and the blade stop. A related objective is to adapt the cover to maintain position of the bracket and provide support for the stop tang

Other objects and advantages of the present invention will be apparent to one of ordinary skill in the art from the teachings herein

### SUMMARY OF THE INVENTION

In achieving the foregoing, and other objectives, one embodiment of the invention provides a blade crossbar for use in a blade suspension assembly including first and second poles The blade crossbar comprises a bar comprising first and second pole sections for supporting the first and second poles. A skirt extends from the bar between the first and second pole sections. The skirt comprises first and second sides adapted to face the first and second poles when the first and second poles are supported by the bar.

In another embodiment, the blade crossbar comprises a molded bar comprising first and second pole sections for supporting the first and second poles. A skirt integral with the bar extends from the bar between the first and second pole sections. The skirt comprises first and second sides adapted to face the first and second poles when the first and second poles are supported by the bar.

In some applications the skirt is adapted to reduce the passing of gases in conductive material between adjacent poles. The skirt, in some embodiments, provides pole to pole isolation. The skirt is preferably adapted to provide, at a minimum, separation between the first and second poles. In some embodiments, the bar and the skirt are contemporaneously molded to form a one-piece crossbar. Some embodiments of the crossbar are molded with one or more blade rests and blade carriers.

One embodiment is directed toward a molded crossbar for use in a 3-pole blade suspension assembly, where the assembly includes first, second and third poles. The blade crossbar comprises a bar comprising first, second and third pole sections, with the second section being between the first and third sections. Each section is adapted to support any one of the first, second and third poles. A first integral skirt extends from the bar between the first and second pole sections. Similarly, a second integral skirt extends from the bar between the second and third pole sections. Thus, the first pole is separated from the second pole and the second pole separated from the third pole when the poles are supported in the first, second and third sections of the blade crossbar. This separation is achieved in a vastly simpler manner as compared with prior art approaches. In one embodiment, drive mechanism parts are coupled to one of the poles before attaching that pole to the crossbar

Another embodiment is directed toward a blade crossbar assembly for use with a blade suspension assembly. The jacket is mountable apart from the bar in a base, for example The jacket is mounted between the first and second poles to cooperate with the skirt to form a barrier between the first and second sections in a plane transverse to the bar The crossbar may, for example, be positioned in a base having a web perpendicular to the crossbar. The jacket is then adapted to interface with the web, and thereby form a barrier perpendicular to the crossbar and between two poles.

In a related embodiment, a jacket, which is adapted for use with a blade crossbar, comprises a top adapted to mount the jacket above the bar. An outer sleeve extends from the top and is adapted to cooperate with the skirt to form a barrier between the first and second pole sections. The crossbar skirt and the outer sleeve are preferably oriented in a parallel relation allowing one to move independent of the other. An alternative embodiment comprises a second outer sleeve extending from the top, parallel to the first outer sleeve, wherein the sleeves are positioned such that the skirt is positioned between the outer sleeves. In an alternate related embodiment, a jacket is adapted for use with a base which supports a blade suspension assembly, where the assembly comprises a blade crossbar supporting first and second poles. The jacket comprises a top adapted to interface with the base and support the jacket above the blade crossbar and between the poles. A portion of the jacket extends downward from the top and toward the blade i5 crossbar to separate the first and second poles.

Another embodiment of the invention is directed toward a blade suspension assembly. The assembly comprises a blade crossbar comprising a bar, which comprises first and second pole sections, and a skirt. The skirt extends from the bar between the first and second sections and comprises a first side adjacent to and facing the first pole, and a second side adjacent to and facing the second pole section. The blade suspension assembly further comprises a first pole and a second pole. The first pole comprises a first blade carrier mounted to the bar in the first pole section. The first blade carrier comprises a pair of arms in which a first blade is pivotally mounted between the arms. The second pole similarly comprises a second blade carrier mounted to the bar in the second pole section. And likewise, a second blade is pivotally mounted between a pair of arms of the second blade carrier. Thus, the blade suspension assembly is provided with substantially identical components and sections, thereby providing for a simple assembly and economical manufacturing. Furthermore, replacement of any one pole is greatly simplified as all poles, satisfying predetermined amperage parameters, are substantially the same. Amperage parameters may be satisfied by, in some embodiments, swapping blades, where the remaining pole components, e.g., blade carriers, are generally identical among the poles.

One embodiment is directed toward a system comprising a blade crossbar, first and second poles mounted to the blade crossbar to form a blade suspension assembly, and a base in which the blade suspension assembly is supported. The blade crossbar comprises a bar, including first and second pole sections, and a skirt integral with and extending from the bar. The skirt extends from the bar between the first and second pole sections. A first pole is mounted in the first pole section and a second pole is mounted in the second pole section. The skirt separates the first and second poles. The base comprises a web having an opening adapted to receive the blade suspension assembly. The base supports the blade suspension assembly such that the skirt is generally aligned with the opening. The web and the skirt separate the first pole and the second pole. A jacket may be positioned in the web to overlap the skirt and provide further pole to pole isolation. A stop-bracket may also be coupled to the base to provide functions associated with both a pivot pin hold down bracket and a blade stop.

### BRIEF DESCRIPTION OF THE DRAWINGS

The foregoing and other advantages of the invention will become apparent upon reading the following detailed description and upon reference to the drawings.

FIG. 1 shows a perspective view of a system in accordance with the invention having a molded crossbar above the base and two removably attachable barriers shown above the crossbar.

FIG. 2 is a perspective view of the system shown in FIG. 1 with the crossbar operatively positioned in the base and the barriers engaging webs of the base. The removably attachable barriers overlap the integral skirts that extend from the bar of the blade crossbar.

FIG. 3 shows a perspective view of the crossbar shown in FIG. 1 with three poles coupled to the crossbar to form a 3-pole blade suspension assembly FIG. 4 depicts a prior art 3-pole blade suspension assembly for comparison to FIG. 3.

FIG. 5 is a partial section view along section line 5-5 of FIG. 2. FIG. 5A shows the removably attachable barrier coupled to be based; FIG. 5B shows the barrier prior to attachment to the base.

FIG. 6 shows a perspective view of the system shown in FIG. 1 further comprising a cover attached to the base. FIG. 6 is rotated relative to FIG. 1 and is shown with a portion of the base removed to illustrate a blade in a closed position and a stop-bracket operatively positioned in a pivot plane of the blade.

FIG. 7 shows the system shown in FIG. 6 with the blade in an open position and an end of the stop-bracket contacting the blade.

FIG. 8 illustrates a perspective view of a blade comprising a uniform blade portion and a haft comprising a grip for interfacing a spring.

FIG. 9 illustrates a multiple torsional spring for use in the blade suspension assembly shown in FIG. 3.

FIG. 10 illustrates a toggle pin having shoulders to maintain correct positions of upper links of the drive pole (the middle pole) shown in FIG. 3.

FIG. 11 shows rivets for attaching lower links to blade carriers.

FIG. 12 shows the stop-bracket shown in FIGS. 6 and 7. The stop-bracket provides functions of a pivot pin hold down bracket and a blade stop bracket.

While the invention is susceptible to various modifications and alternative forms, specific embodiments have been shown by way of example in the drawings and will be described in detail herein It should be understood, however, that the invention is not intended to be limited to the particular forms disclosed. Rather, the invention is to cover all modifications, equivalents, and alternatives falling within the spirit and scope of the invention as defined by the appended claims

### DETAILED DESCRIPTION OF THE ILLUSTRATED EMBODIMENTS

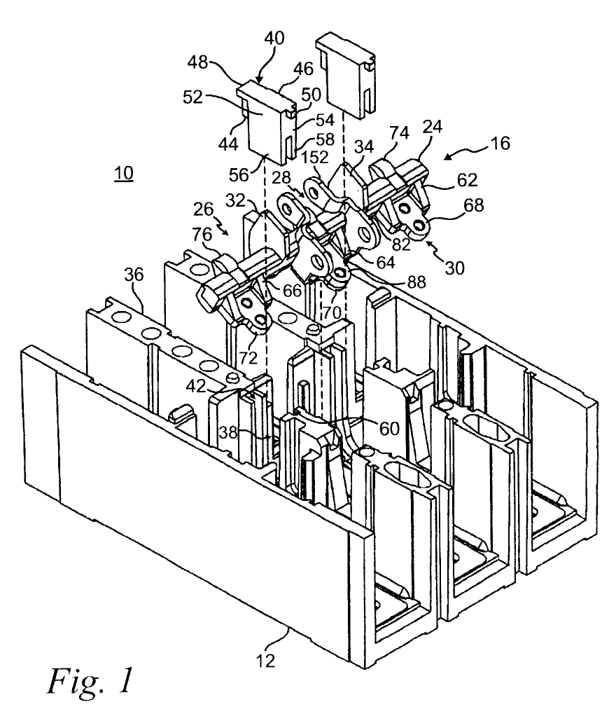

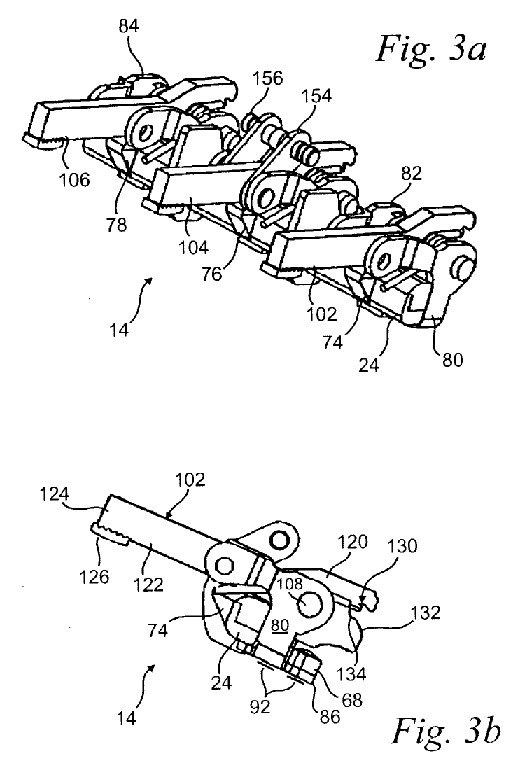

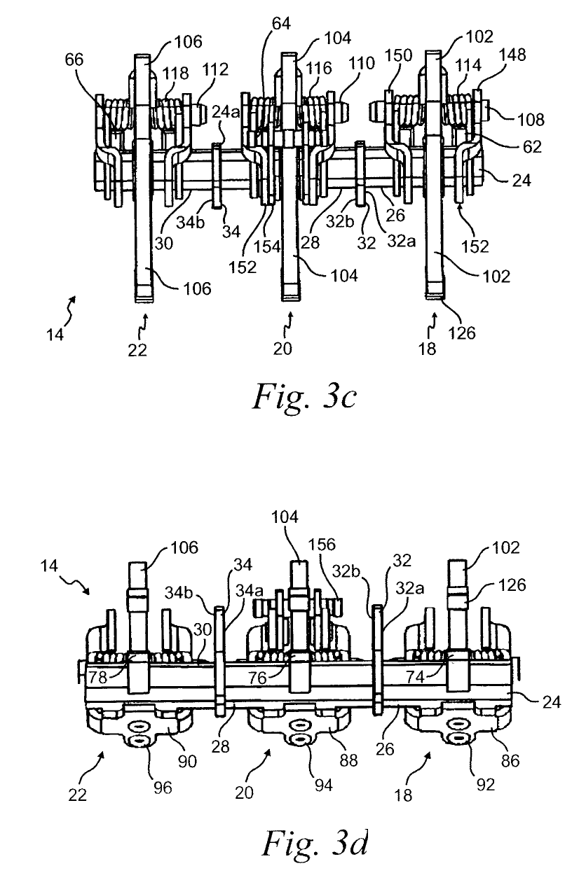

FIG. 1 shows an exploded perspective view of a system 10 for affording protection in an electrical connection The system 10 comprises a base 12 adapted to support a suspension assembly 14 (see FIG. 3). The suspension assembly 14 comprises a blade crossbar 16 and a plurality of poles 18, 20, and 22

The blade crossbar 16 comprises a bar 24 which includes first and second pole sections 26 and 28. In a 3-pole system the bar includes a third pole section 30. A skirt 32, which is preferably integral with the bar 24, extends from the bar 24 between the first and second pole sections 26 and 28. Similarly, a second skirt 34 extends from the bar 24 between the second and third pole sections 28 and 30. The first skirt 32 comprises a first side 32a facing the first pole 18 and a second 32b facing the second pole 20. Similarly, the second skirt 34 comprises a first side 34a facing the second pole 20 and a second side 34b facing the third pole 22. In some embodiments, the skirt 32 is generally flat, comprising only two faces, namely the first side 32a and the second side 32b.

As illustrated in FIG. 3, the first, second and third poles 18, 20 and 22 are positioned in the first, second and third pole sections 26, 28 and 30. The base 12 comprises a web 36 having an opening 38 adapted to receive the blade suspension assembly 14. The skirt 32 is generally aligned with the opening 38 such that the web 36 and the skirt 32 separate the first pole 18 and the second pole 20. To reduce mechanism size and complexity, the skirt 32 may be sized to operate within the opening 38 in a plane comprising the web 36.

For some applications, the system further comprises a jacket 40 adapted to engage the opening 38 in the web 36. The jacket 40 is positioned above the bar 24 of the blade suspension assembly 14. In some embodiments the web 36 defines a slot 42 associated with the opening 38. The skirt 32 interfaces with the slot 42 when the suspension assembly 14 is operatively positioned in the base 12. The skirts, 32 and 34, are preferable integral with the blade crossbar 16 and interface with the slots, e.g., slot 42, built into the base 12 to keep material from opposing poles entering across the opening 38 for the bar 24. The jacket 40 may be a molded barrier which is then inserted into slot 42 in the base to complete in enclosing skirt 32

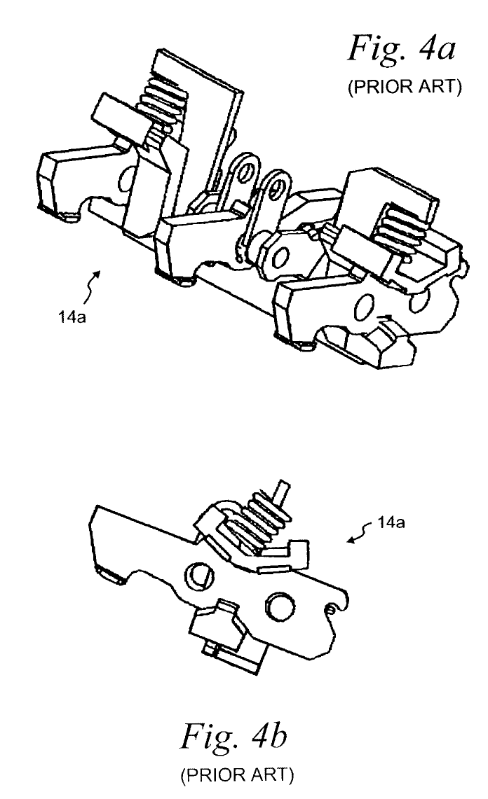

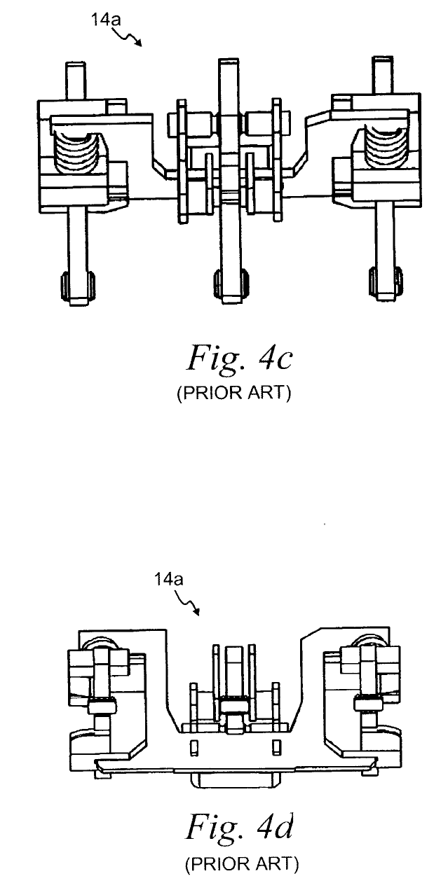

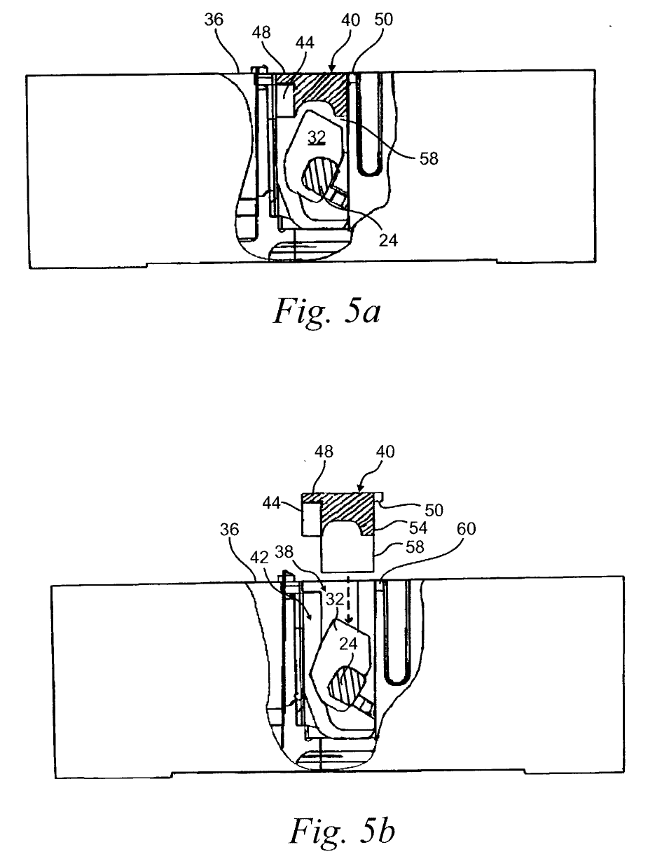

In some embodiments the jacket 40 comprises a guide 44 for interfacing the slot 42 In FIGS. 1 and 5, the guide 44 is aligned with the skirt 32 when the jacket 40 engages the opening 38 The jacket 40 comprises a top 46 adapted to mount the jacket 40 in the web 36. The top 46 comprises first and second opposing projections 48 and 50 for supporting the jacket 40 above the bar 24 and for engaging the web 36 The jacket 40 comprises a portion 52 extending downward from the top 46 and adapted to align with the web 36 The portion 52 cooperates with the skirt 32 to form a barrier between the first and second poles 18 and 20. The portion 52 may also be adapted to cooperate with the skirt 32 to form a barrier between the first and second poles while allowing the skirt 32 to rotate with the bar 24.

In some embodiments it is advantageous to use a one-piece molded crossbar 16 which has integral skirts 32 and 34 so that no other parts are mounted to the bar to achieve pole to pole isolation. The skirts 32 and 34 may be shaped to interface with the base, which further reduces the tendency of passing gases and conductive material to adjacent poles. A molded phase barrier, for example, the jacket 40, may be inserted into for example a slot 42, between poles 18 and 20 to complete enclosing a skirt 32 and form a phase barrier between the poles.

The portion 52 of the jacket 40 extending downward comprises, in some embodiment, a beam 54 adapted to be positioned above the skirt 32. The beam 54 is shown formed to allow the skirt 32 to rotate with the bar 24. The portion 52 extending toward the bar 24, e.g., downward, may also comprise an outer sleeve 56 adapted to overlap the skirt 32 while allowing the skirt 32 to rotate with the bar 24. The jacket 40 may further comprise another outer sleeve 58 extending downward from the top 46 in parallel relation to the outer sleeve 56 and the skirt 32. The jacket 40 is adapted to cooperate with the skirt 32 such that the skirt 32 is positioned between the outer sleeves 56 and 58. The guide 44 facilitates aligning the jacket 40 as the jacket 40 is positioned in the opening 38. The guide 44 is below the first projection 48 and engages the slot 42 before the opposing projection 50 engages depression 60 in web 36. The depression 60 is, in some applications, another slot. Engagement with depression 60 aids rotationally stability and vertical support as does engagement with guide 44.

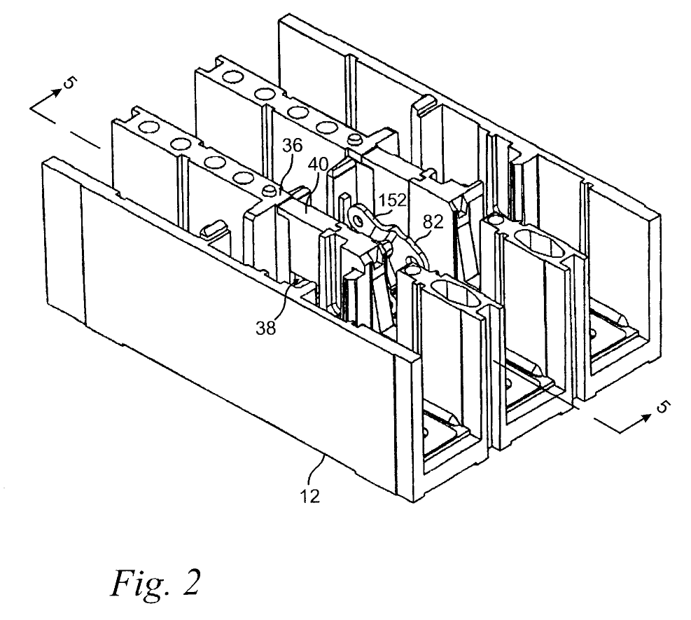

FIG. 2 shows the system 10 with the crossbar 16 positioned in the base 12 and the jacket 40 placed in the web 36. FIG. 3 illustrates the blade suspension assembly 14 and FIG. 4 illustrates a prior art suspension assembly 14A. FIG. 3A is a perspective view of the blade suspension assembly 14. FIG. 3B shows a side view of the blade suspension assembly shown in FIG. 3A. FIG. 3 is a top view of the blade suspension assembly 14 shown in FIG. 3A FIG. 3D shows the blade suspension assembly 14 shown in FIG. 3C rotated about an axis through the bar 24 to show the floor of the blade carriers FIGS. 4A, 4B, 4C and 4D illustrate views of a prior art 3-pole blade suspension assembly 14A where the views correspond to those shown in FIGS. 3A-3D.

For some applications the blade crossbar is a molded crossbar 16 comprising integral first, second and third blade carrier mounts 62, 64 and 66. Each of the blade carrier mounts 62, 64 and 66 comprise, respectively, a first bottom 68, a second bottom 70, and a third bottom 72. Each of the bottoms of the blade carrier mounts extend from the bar 24. In some embodiments the bar 24 is molded and includes the bottoms 68, 70 and 72 extending from the bar perpendicular to a longitudinal axis running through the bar 24. Also illustrated in FIG. 1 are first, second and third integral blade rests 74, 76 and 78 extending from the bar 24. Each of the blade rests is aligned with a corresponding blade carrier mount 62, 64 and 66 and is shown extending in a generally opposing direction.

FIG. 5A shows a section view along Section line 5-5 shown in FIG. 2. For clarity only a portion of the view is shown. FIG. 5B shows the section view shown in FIG. 5A prior to inserting the jacket 40 into the opening 38 in the web 36.

The blade suspension assembly 14 further comprises a first blade carrier 80 mounted to the first blade carrier mount 62, a second blade carrier 82 mounted to the second blade carrier mount 64 and a third blade carrier 84 mounted to the third blade carrier mount 66. As seen in FIG. 3D, a first floor 86 of the first blade carrier 80 is mounted to the blade crossbar 16. Similarly, each of the second and third blade carriers 82 and 84 comprise corresponding second and third floors 88 and 90. Each of the floors 86, 88 and 90 are mounted to the crossbar 16 with pairs of rivets 92, 94 and 96. FIG. 11 illustrates an exemplary rivets 98 and 100 for mounting a lower link to a blade carrier. FIG. 11A is a perspective view of the rivet 98; FIG. 11B is a side view of rivet 98 and FIG. 11C is a side view of rivet 100 A tubular rivet is preferably used to mount the carrier to the bar Using a low height attachment, such the pair of rivets 92, the carrier 80 is mounted to the crossbar 16 with sufficient clearance for the blade 102 to blow open during high fault levels.

FIG. 3 illustrates a first blade 102 pivotally mounted in the first blade carrier 80 with a first pivot pin 108. Likewise a second blade 104 is pivotally mounted in the second blade carrier 82 with a second pivot pin 110 and a third blade 106 as pivotally mounted and a third blade carrier 84 with a third pivot pin 112. The first, second and third pivot pins 108, 110 and 112 are axially aligned so each of the first, second and third blades 102, 104 and 106 pivot about a common axis. The common pivot axis is spaced apart from and rotates with the bar 24. In some embodiments each of the first, second and third blades 102, 104 and 106 are preloaded with a corresponding flat rate contact pressure spring. Thusly, each of the first, second and third blades 102, 104 and 106 may be biased to rest on corresponding blade rests 74, 76 and 78. The illustrated pressure springs are torsional springs. Accordingly, first, second and third torsional springs 114, 116 and 118 are respectively mounted on first, second and third pivot pins 108, 110 and 112.

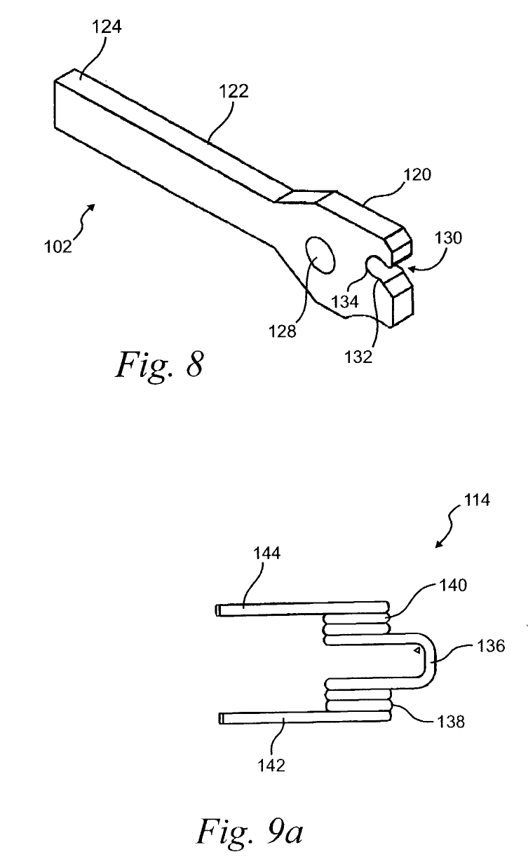

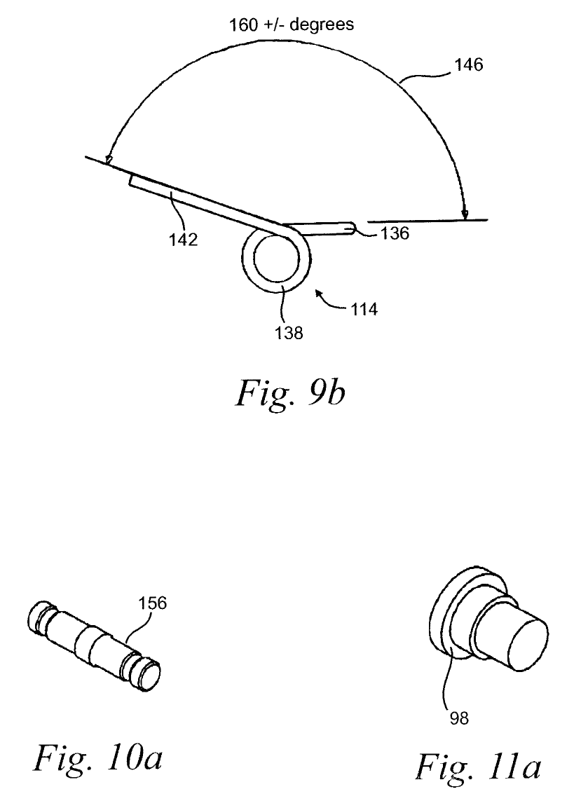

A perspective view of the first blade is illustrated in FIG. 8, and top and side views of the first torsional spring 114 are illustrated in FIGS. 9A and 9B. The first blade 102 comprises a blade haft 120 and a blade portion 122 extending from the blade haft 120. To reduce complexity the blade portion 122 comprises a generally smooth cross section from the haft 120 to an end the blade 124. The illustrated blade portion 122 comprises a generally uniform cross section having a thickness of 0.156 inch. A smooth cross section is generally devoid of reduced portions. See FIG. 4 and U.S. Pat. No. 5,539,167 for examples of blades having a reduced portion. As used herein smooth cross section may comprise a uniform cross section or a tapered cross section, while being devoid of reduced portions.

A contact 126 suitable for predetermined amperage parameters is attached to the end 124 of the blade 102. The blade haft 120 defines a pinhole 128 through which the first pivot pin 108 is inserted. The position of contact 126 may be changed by, for example, rotation of bar 24, or rotation of blade 102 about pivot pin 108, or a combination of rotations of both

Contact pressure is maintained by the torsional spring 114 preloading the blade 102. The haft 120 defines a grip 130 for interfacing with the torsional spring 114. The grip 130 comprises a lip 132 and to a divot portion 134, wherein the spring 114 is positioned in the divot portion 134.

FIG. 9 illustrates the torsional spring 114 in the form of a multi-coiled torsional spring comprising a middle section 136 positioned between first and second coils 138 and 140 Each of the coils 138 and 140 comprise a plurality of windings Each of the coils 138 and 140 end in a corresponding tang 142 and 144. The relaxed angle 146 between the tangs 142 and 144 and the middle section 136 is, for some applications, approximately 160 degrees. The middle section 136 rests in the divot portion 134 while the tangs 142 and 144 press against the blade carrier 80.

One of ordinary skill in the art will understand the significant advantages achieved with a kit in accordance with the teachings herein. For example, the poles may be adapted to be interchangeable and the components of the poles may be interchangeable. The poles are easily formed and attached to the crossbar to provide a blade suspension assembly. For example, the first pole 18 may be formed by coupling the divot portion 134 with the middle section 136 of the spring 114, aligning the pin hole 128 between the first and second coils 138 and 140, and inserting the pivot pin 108 through the first coil 138, the pin hole 128 and the second coil 140. After coupling the blade 102 with the torsional spring 114, the pivot pin 108 may be inserted into first and second arms 148 and 150 of the first blade carrier 80. The spring 114 is positioned by pressing the tangs 142 and 144 between the first and second arms 148 and 150, which extend upward from the floor 86 of the first blade carrier 80. The first blade carrier 80 may then be mounted to the bottom 68 of the blade carrier mount 62 with the first pair of rivets 92. Typically, the spring 114 is preloaded, and hence the blade 102 is preloaded, during the mounting phase.

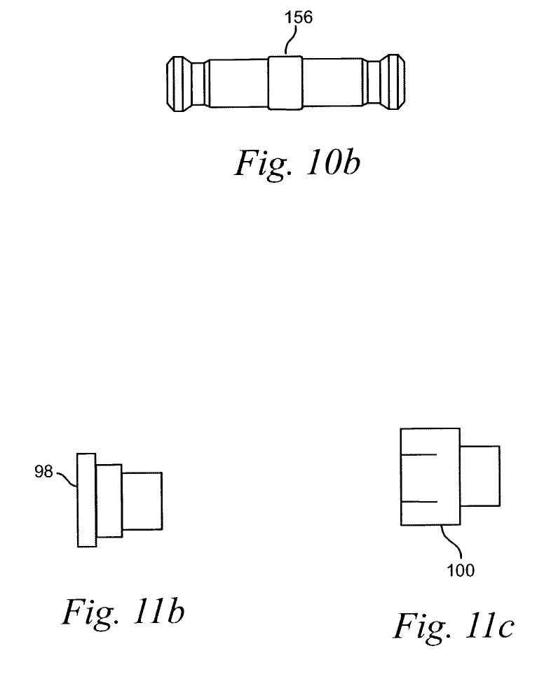

Often one pole of a plurality of coupled poles is a drive pole. To simplify the design, each pole may be designed to be substantially identical. For example, each pole may be adapted to couple with a drive mechanism, or a mechanism for coupling the pole to a drive mechanism. In some pole embodiments, the arms of the blade carrier comprises an extension 152 may be connected with two lower links 154, via two lower link rivets (e g, rivets 98). Typically when a pole is to function as a drive pole, the two lower link rivets, the two lower links and a toggle pin are installed prior to installation of the blade carrier on the crossbar. The blade suspension assembly 14 illustrated in FIG. 3 is a 3-pole mechanism and the center pole, e.g., the second pole 20, is adapted to be a drive pole. The second pole 20 comprises an extension 152 of the blade carrier 82. A toggle link 154 has end coupled to the first and second arms of the blade carrier and a free end. The free end is attached to a toggle pin 156. FIG. 10 illustrates an embodiment of the toggle pin 156 FIG. 10A shows a perspective view of the shouldered toggle pin 156 FIGS. 10B and 10C show side and end views, respectively, of the toggle shoulder pin 156 shown in FIG. 10A.

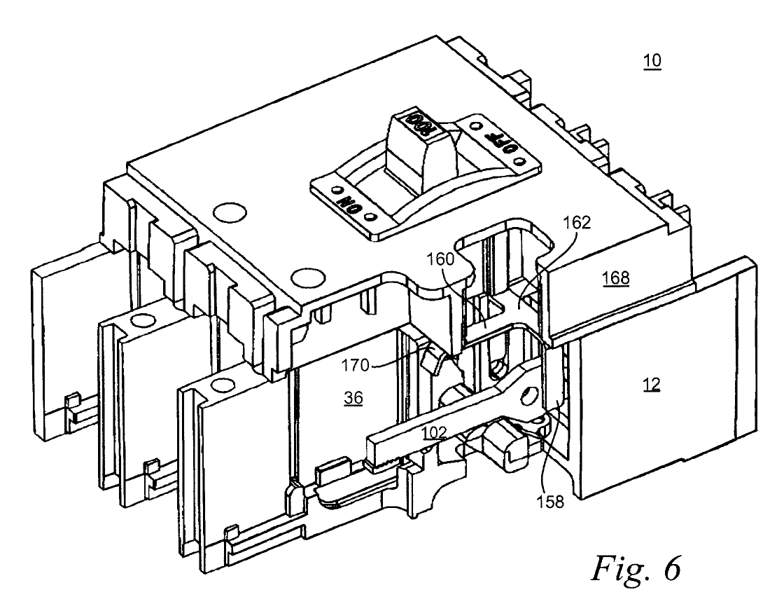

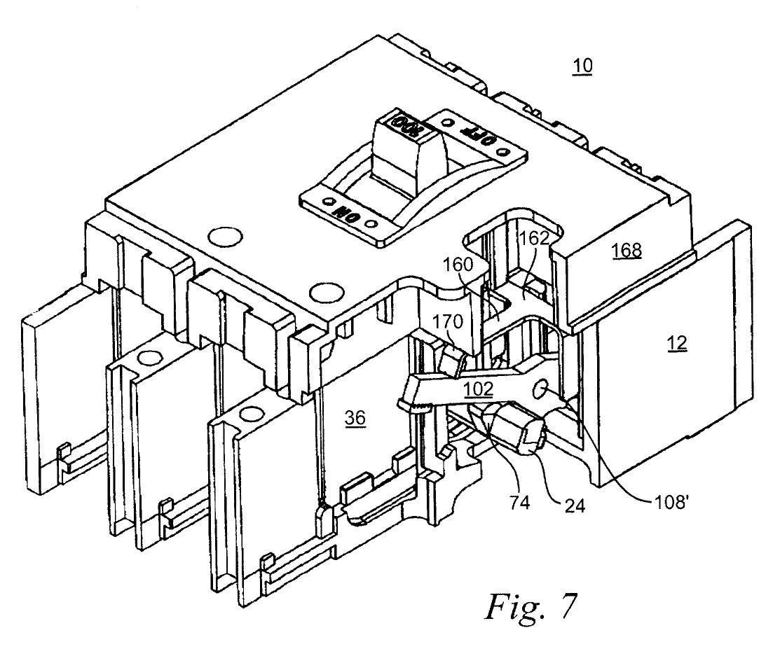

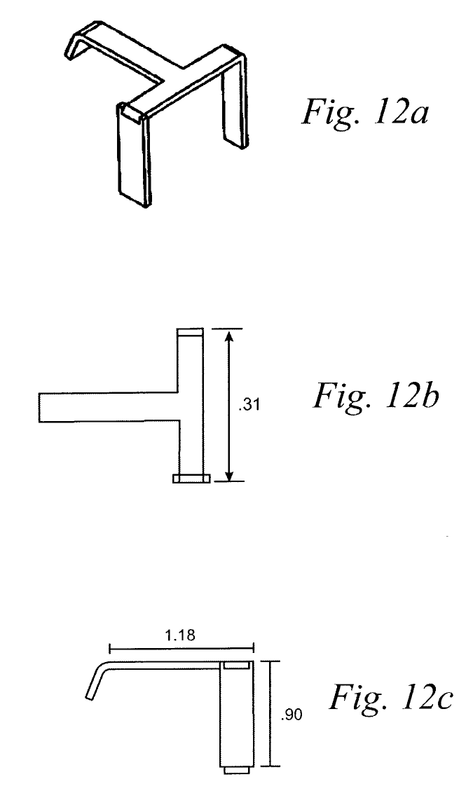

A stop-bracket 158, illustrated in FIGS. 6, 7 and 12, is a combination blade stop and pivot pin bracket. If provides functions of both and comprises a stop tang 160 extending from a bracket portion 162. The bracket portion 162 is supported by the base 12 near a pivot point (indicated in FIG. 7 by the first pivot pin hole 108′) and oriented such that the stop tang 160 is operably positioned to contact and limit travel of the first blade 102. A cover 168 is coupled to the base 12 and interfaces the stop bracket 158 at the bracket portion 162, proximate to the pivot point. The cover 168 also interfaces with an end 170 of the stop tang 160. FIG. 7 illustrates the first blade 102 in an open position, contacting the end 170 of the stop-bracket 158, FIG. 6 illustrates the first blade 102 in a closed position, i.e., allowing current to flow. The toggle link 154 is also known as a pair of lower links.

The lower links 154 transmit the mechanism of forces to the drive pole carrier 82 through the lower link rivets. This force in turn drives the blade carrier 82 to apply force to the crossbar 16. The outboard pole blades, e.g., blades 102 and 106, receive force through their respective carriers 80 and 84 and contact pressure springs 114 and 118, The crossbar 16 also provides the distribution of the drive force from the mechanism to all of the poles and provides the blade rest (74, 76 and 78), that drive the blade open during trip and off operations and determine over travel during the on operation.

While the illustrated embodiments have been described with relational terms such as up, down, above and the like, one of ordinary skill in the art will understand that use of such terms is for clarity, not for describing absolute positions or orientations. Similarly, use of such terms in the claims is to describe relative relations and not to describe absolute positions and orientations, except where indicated. And while particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims

What is claimed is:

1 A blade crossbar for use in a blade suspension assembly including first and second poles, wherein the blade crossbar comprises:
a bar comprising first and second pole sections for supporting the first and second poles; and
a skirt extending from the bar between the first and second pole sections, wherein the skirt comprises first and second sides adapted to face the first and second poles when the first and second poles are supported by the bar.

2. The blade crossbar of claim 1, wherein the skirt is generally flat.

3. The blade crossbar of claim 1, wherein the skirt is rotatable with the bar.

4. The blade crossbar of claim 1, wherein the first and second pole sections comprise first and second blade rests rotatable with the bar.

5. The blade crossbar of claim 4, wherein the first and second pole sections comprise first and second carrier mounts adapted to couple with the first and second poles.

6 The blade crossbar of claim 5, wherein the first blade rest extends from the bar in a first direction and the first carrier mount extends from the bar in a second direction generally opposing the first direction.

7. The blade crossbar of claim 6, wherein the skirt, the first and second blade rests, and the first and second carrier mounts are integral with the bar.

8 The blade crossbar of claim 1, wherein the skirt is integral with the bar

9. A blade crossbar for use in a blade suspension assembly including first and second poles, wherein the blade crossbar comprises:
a molded bar comprising first and second pole sections for supporting the first and second poles; and
an integral skirt extending from the bar between the first and second pole sections, wherein the skirt is integrally molded with the bar and comprises first and second sides adapted to face the first and second poles when the first and second poles are supported by the bar.

10. The blade crossbar of claim 9, comprising a first integral blade rest extending from the bar, wherein the first blade rest is integrally molded with the bar.

11. The blade crossbar of claim 9, comprising a first integral carrier mount in the first pole section adapted to support a blade carrier, wherein the first integral carrier mount is integral with and extends from the bar.

12. A blade crossbar for use in a three-pole blade suspension assembly including first, second and third poles, wherein the blade crossbar comprises:
a bar comprising first, second and third pole sections, the second section being between the first and third sections and the sections being adapted to respectively support first, second and third poles;
a first integral skirt extending from the bar between the first and second pole sections, whereby
a second integral skirt extending from the bar between the second and third sections
the blade crossbar separates the first pole from the second pole and the second pole from the third pole when the poles are supported in the first, second and third sections

13. The blade crossbar of claim 12, wherein the first, second and third pole sections are molded to be substantially identical, whereby one pole adapted to be mounted in any one of the three-pole sections is mountable in any one of the other two pole sections.

14. The blade crossbar of claim 12, wherein each pole section comprises an integral carrier mount, wherein the mounts are integrally molded with the bar.

15. The blade crossbar of claim 14, wherein each carrier mount comprises a bottom adapted to mount to a blade carrier and each carrier mount is substantially identical.

16. The blade crossbar of claim 14, wherein each pole section comprises a blade rest integrally molded with the bar.

17. The blade crossbar of claim 12, wherein the first and second skirts are substantially flat.

18. A blade crossbar assembly for use with a blade suspension assembly having first and second poles, wherein the crossbar assembly comprises:
a bar comprising first and second pole sections adapted to support the first and second poles;
a skirt extending from the bar between the first and second pole sections; and
a jacket mountable apart from the bar and positioned between the first and second poles to cooperate with the skirt to form a barrier between the first and second pole sections in a plane transverse to the bar.

19. The assembly of claim 18, wherein the jacket overlaps the skirt.

20. The assembly of claim 19, wherein the skirt moves relative to the jacket when the bar rotates

21. The assembly of claim 19, wherein the jacket comprises outer sleeves overlapping the skirt when the jacket is mounted to form the barrier and, wherein the outer sleeves are sufficiently spaced apart to fit the skirt between the outer sleeves.

22. The assembly of claim 21, wherein the jacket comprises a beam between the outer sleeves, wherein the beam is formed to allow the skirt to move when the jacket is overlapping the skirt.

23. A jacket adapted for use with a blade crossbar in a suspension assembly, wherein the blade crossbar comprises a bar having a skirt extending therefrom and separating first and second pole sections thereof, and wherein the jacket comprises
a top adapted to mount the jacket in a relatively fixed position,
an outer sleeve extending from the top toward the bar and adapted to cooperate with the skirt to form a barrier between the first and second pole sections, wherein the skirt and the outer sleeve are oriented in parallel relation.

24. The jacket of claim 23, wherein the outer sleeve overlaps the skirt.

25. The jacket of claim 24, wherein the outer sleeve is maintained in a fixed position as the skirt moves with the bar.

26. The jacket of claim 23, wherein the outer sleeve is a first outer sleeve and the jacket further comprises another outer sleeve extending from the top toward the bar in parallel relation to the first outer sleeve and to the skirt, wherein the skirt is positioned between the outer sleeves when the jacket is mounted.

27 The jacket of claim 23, wherein the top comprises first and second opposing projections adapted to support the jacket in the relatively fixed position.

28. A jacket adapted for use with a base supporting a blade suspension assembly comprising a blade crossbar supporting first and second poles, wherein the jacket comprises:
a top adapted to interface with the base and support the jacket between the poles; and
a portion extending from the top toward the blade crossbar wherein the portion is adapted to separate the first and second poles.

29. The jacket of claim 28, wherein the blade crossbar comprises a skirt between the first and second poles and the portion extending toward the blade crossbar comprises an outer sleeve overlapping the skirt.

30. The jacket of claim 28, wherein the top comprises opposing first and second projections interfacing a web in the base and wherein the projections support the jacket relative to the blade crossbar

31. The jacket of claim 30, wherein at least one of the first and second projections engages a slot in the web, and wherein the slot is associated with an opening in the web for receiving the blade crossbar.

32. The jacket of claim 31, wherein the second projection engages the slot and the jacket comprises and a guide below the first projection engaging another slot in the web of the base.

33. The jacket of claim 32, comprising a first outer sleeve extending from the top toward the blade crossbar and adapted to align with the web and to cooperate with a skirt extending from a bar of the blade crossbar to form a barrier between the first and second poles.

34 The jacket of claim 33, wherein the first outer sleeve is adapted to overlap the skirt, and wherein the web, the skirt and the first outer sleeve are generally parallel.

35. The jacket of claim 34, comprising a second outer sleeve parallel to the first outer sleeve and adapted to overlap the skirt and allow the skirt to slide between the first outer sleeve and the second outer sleeve.

36. The jacket of claim 28, wherein the portion extending toward the blade crossbar is adapted to cooperate with a skirt extending from a bar of the crossbar to form a barrier between the first and second poles while allowing the skirt to move with the bar.

37. The jacket of claim 36, wherein the portion extending toward the blade crossbar comprises a beam adapted to be positioned apart from and parallel with the skirt and wherein the beam is formed to allow the skirt to move with the bar.

38. The jacket of claim 37, wherein the portion extending toward the blade crossbar comprises an outer sleeve integral with the beam and adapted to overlap the skirt while allowing the skirt to move with the bar.

39. The jacket of claim 38, wherein the top and the portion extending toward the blade crossbar form a single molded piece.

40. A blade suspension assembly comprising:
a blade crossbar comprising:
a bar comprising first and second pole sections, and
a skirt extending from the bar between the first and second pole sections, wherein the skirt comprises.
a first side facing the first pole section, and
a second side facing the second pole section, and wherein the blade suspension assembly further comprises:
a first pole mounted to the blade crossbar in the first pole section; and
a second pole mounted to the blade crossbar in the second pole section, wherein the skirt separates the first pole from the second pole

41. A blade suspension assembly comprising:
a blade crossbar comprising.
a bar comprising first and second pole sections,
a skirt extending from the bar between the first and second sections, and comprising
a first side adjacent to and facing the first pole section and
a second side adjacent to and facing the second pole section;
the blade suspension assembly further comprising:
a first pole comprising:
a first blade carrier mounted to the bar in the first pole section, wherein the first blade carrier comprises a pair of arms, and
a first blade pivotally mounted between the pair of arms; and the blade suspension assembly further comprising:
a second pole comprising:
a second blade carrier mounted to the bar in the second pole section, wherein the second blade carrier comprises a pair of arms; and
a second blade pivotally mounted between the pair of arms of the second blade carrier.

42. The blade suspension assembly of claim 41, wherein:
the blade crossbar comprises:
a first blade carrier mount integral with the bar and located in the first pole section, and
a second blade carrier mount integral with the bar and located in the second pole section;
the first blade carrier is mounted to the first blade carrier mount; and
the second blade carrier is mounted to the second blade carrier mount.

43. The blade assembly of claim 42, wherein:
the first blade carrier comprises a floor between the first blade carrier pair of arms, the floor being mounted to the first blade carrier mount; and
the second blade carrier comprises a floor between the second blade carrier pair of arms, the floor being mounted to the second blade carrier mount.

44. The blade suspension assembly of claim 41, wherein the blade crossbar comprises:
a first blade rest integral with the bar and located in the first pole section; and
a second blade rest integral with the bar and located in the second pole section.

45. The blade suspension assembly of claim 41, wherein the skirt is integral with the bar and move as the bar rotate.

46. A system comprising:
a blade crossbar comprising
a bar including first and second pole sections, and
a skirt integral with and extending from the bar between the first and second pole sections;
a first pole mounted in the first pole section;
a second pole mounted in the second pole section, wherein the skirt separates the first and second poles, and the first and second poles mounted on the blade crossbar form a blade suspension assembly; and
the system further comprises:
a base adapted to support the blade suspension assembly, wherein the base comprises a web having an opening adapted to receive the blade suspension assembly with the skirt generally aligned with the opening such that the web and the skirt separate the first pole and the second pole

47. The system of claim 46, comprising a jacket adapted to engage the opening in the web, with the bar between jacket and the base

48. The system of claim 47, wherein the web defines a slot in the opening, and wherein the skirt interfaces with the slot when the suspension assembly is operatively positioned in the base.

49. The system of claim 48, wherein the jacket comprises a guide interfacing the slot, and wherein the guide is aligned and parallel with the skirt when the jacket engages the opening.

50. The system of claim 48, wherein the jacket comprises an outer sleeve overlapping the skirt when the jacket is positioned in the opening, whereby the jacket, the skirt and the web separate the first pole and the second pole.

51. A method of manufacturing a blade crossbar for use in a blade suspension assembly, wherein the method comprises:
forming a bar adapted to support two poles;
forming an integral separating member extended from the bar; and
positioning the integral separating member to separate the poles supported by the bar

52. The method of claim 51, comprising molding the bar and the separating member to be a one-piece blade crossbar adapted to support two poles with the separating member between the poles.

53 The method of claim 51, comprising molding the blade crossbar with a blade rest corresponding to each pole.

54. The method of claim 51, comprising molding the blade crossbar with a blade carrier mount corresponding to each pole.

55. A method of manufacturing a blade suspension assembly comprising:
forming a blade crossbar to have an integral separating member positioned between two pole sections;
attaching one pole to the crossbar on one side of the integral separating member; and
attaching another pole to the crossbar on an opposite side of the separating member so the separating member is between the two poles.

56. The method of claim 55, comprising molding the integral separating member contemporaneously with a bar of the blade crossbar such that the bar will be integrally connected with the integral separating member when the blade crossbar is formed and at least one blade carrier is mounted on the formed blade crossbar.

57. A method of manufacturing a blade crossbar, the method comprising
molding a bar;
molding three spaced apart blade carrier mounts, wherein the mounts are molded to the bar,
molding two separating members to the bar; and
positioning one of the two separating members between two of the spaced apart blade carrier mounts.

58. The method of claim 57, comprising molding a blade rest to the bar to be operable with one of the blade carrier mounts.

59. A blade suspension kit comprising:
a preformed blade crossbar comprising a pole separating member between first and second pole sections, wherein the preformed blade crossbar is molded with the pole separating member,
a first blade carrier adapted to be attached to the preformed blade crossbar, and
a second blade carrier substantially identical to the first blade carrier.

60. The kit of claim 59, wherein the preformed blade crossbar is molded with two integral blade rests with the pole separating member positioned between the two integral blade rests.

61. The kit of claim 59, wherein the preformed blade crossbar is molded with two integral blade carrier mounts with the pole separating member positioned between the two integral blade carrier mounts.

62. The kit of claim 59, comprising two substantially identical springs, each adapted to be individually mounted in both of the blade carriers.

63. A blade carrier kit for use in a blade suspension assembly, the kit comprising:
a first blade carrier having a floor adapted to mount to a crossbar;
a second blade carrier substantially identical to the first blade carrier,
a first blade adapted to be pivotally mounted in the first and second blade carriers;
a second blade adapted to be pivotally mounted in the first and second blade carriers, the second blade being substantially identically to the first blade;
a first spring adapted to mount in the first and the second blade carriers; and
a second spring substantially identical to the first spring.

64. The kit of claim 63, wherein the first blade comprises a blade portion comprising a generally smooth cross-section from a haft of the blade to an end of the blade.

65. The kit of claim 64, wherein the generally smooth cross-section is generally uniform from the haft to the end of the blade.
